(19) United States
(12) Patent Application Publication
(10) Pub. No.: US 2011/0197859 A1
(43) Pub. Date: Aug. 18, 2011

(54) Dynamically Altering Piston Displacement

(76) Inventor: Kelce S. Wilson, Murphy, TX (US)

(21) Appl. No.: 13/092,917

(22) Filed: Apr. 23, 2011

(51) Int. Cl. F02B 75/04

(52) U.S. Cl. 123/48 R

(57) ABSTRACT

Systems are disclosed that enable an internal combustion engine to dynamically alter piston displacement. The alteration is dynamic, because it occurs during engine operation, rather than requiring stopping and disassembling the engine. It is piston displacement that is altered, rather than engine displacement, because the actual volume that is displaced by a piston (as it moves within a cylinder) is altered. This is contrasted with the prior art practice of starving some cylinders of fuel. Because “engine displacement” is conveniently defined in prior art multi-displacement systems, to include only cylinders that actively produce power, the fuel-starved cylinders are excluded from a calculation of “engine displacement” and thus the “engine displacement” allegedly changes. The disclosed dynamic alteration of piston displacement is the alteration of actual displaced cylinder volume, and is differentiated from alteration of engine displacement.

### TECHNICAL FIELD

The invention relates generally to internal combustion engines. More particularly, and not by way of any limitation, the present application relates to fuel saving methods for gasoline engines.

### BACKGROUND

Multi-displacement engines art known in the art as systems that suspend supplying fuel to a certain set of cylinders, in an effort to save fuel when the demand on engine power is reduced. For example, some V8 engines will suspend the flow of gasoline to 4 of the 8 cylinders, under certain speed and engine load conditions.

There are at least 3 primary shortcomings with such a prior art system: (1) The mechanical drag on the engine, caused by actuating the valves and pumping the pistons within each fuel-starved cylinder, remains and therefore reduces engine efficiency; (2) the engine displacement can only be varied in a small number of increments, and the step sizes are large, such as abruptly cutting engine displacement by 50%; and (3) only up to half of the cylinders are eligible for cut-out, in order to maintain balance between power and internal drag within the engine.

This third shortcoming introduces two significant derivative limitations. The prior art multi-displacement engine systems that cut out select cylinders (1) can only be used in engines with an even number of cylinders; and (2) cannot be used with single cylinder engines, such as those found in lawnmowers and some motorcycles.

### BRIEF DESCRIPTION OF THE DRAWINGS

For a more complete understanding of the present invention, reference is now made to the following descriptions taken in conjunction with the accompanying drawings:

FIG. 1 illustrates an embodiment of a system that is operable to dynamically alter piston displacement.

FIG. 2 illustrates a piston at full retraction and a cylinder at the greatest displacement position.

FIG. 3 illustrates a piston at full retraction and a cylinder at the least displacement position.

FIG. 4 illustrates a perspective view of a portion of the system illustrated in FIGS. 1 through 3.

FIG. 5 illustrates a portion of a valve assembly for an engine configured to allow dynamic alteration of piston displacement.

FIG. 6 illustrates another portion of a valve assembly for an engine configured to allow dynamic alteration of piston displacement.

FIG. 7 illustrates an embodiment of a valve assembly for an engine configured to allow dynamic alteration of piston displacement.

FIG. 8 illustrates a flowchart of a method of dynamically altering piston displacement.

FIG. 9 illustrates a flowchart of another method of dynamically altering piston displacement.

### DETAILED DESCRIPTION OF THE INVENTION

A system is disclosed that enables an internal combustion engine to dynamically alter piston displacement. The alteration is dynamic, because it occurs during engine operation, rather than requiring stopping and disassembling the engine. It is piston displacement that is altered, rather than engine displacement, because the actual volume that is displaced by a piston (as it moves within a cylinder) is altered. This is contrasted with the prior art practice of starving some cylinders of fuel. Because “engine displacement” is conveniently defined in prior art multi-displacement systems, to include only cylinders that actively produce power for the engine, any fuel-starved cylinder is excluded from a calculation of “engine displacement” and thus the conveniently-defined “engine displacement” allegedly changes. The disclosed dynamic alteration of piston displacement is the alteration of actual displaced cylinder volume, and is differentiated from alteration of engine displacement.

The system overcomes several shortcomings and limitations of the prior art multi-displacement systems: (1) the mechanical drag on an engine, caused by actuating the valves and pumping a pistons within a fuel-starved cylinder, is eliminated. With the disclosed system, no piston must be pumped unnecessarily within a “dead” cylinder that fails to produce power for the engine. (2) Displacement can be varied in such a large number of increments, with step sizes that are so small (even for a digitally-controlled system), that the alteration can be effectively continuous in arbitrarily small amounts. (3) All cylinders in a multi-cylinder engine are candidates for displacement alteration. (4) The new system can be used with any arbitrary number of cylinders, including 3 and 5 cylinder engine configurations. (5) The new system can be used in a single-cylinder engine.

The advantages thus described can be significant, and their notable absence from the prior art attests to the novelty of the disclosed systems.

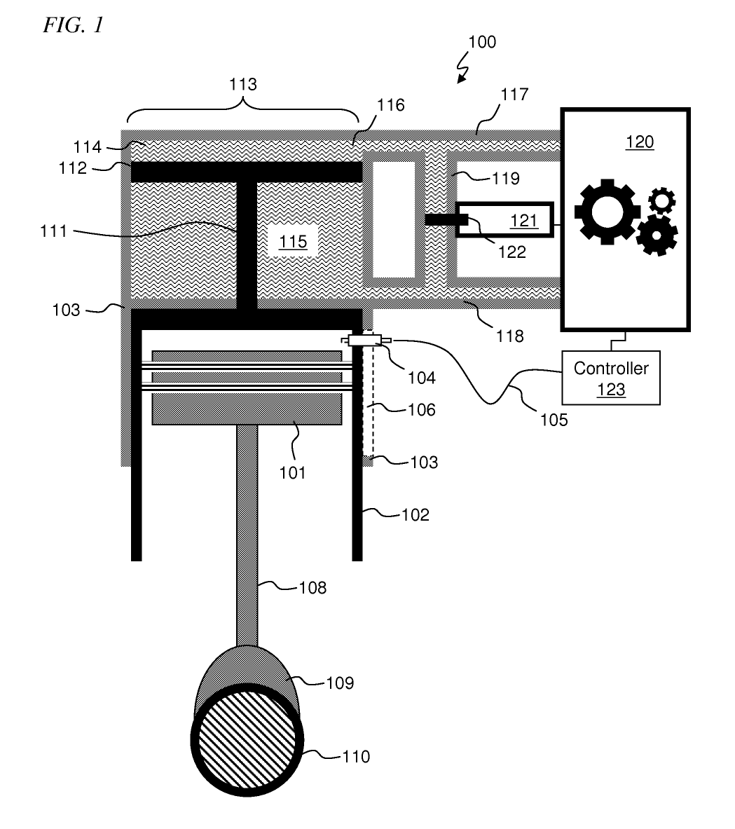

FIG. 1 illustrates an embodiment of a system 100 that is operable to dynamically alter piston displacement. A power piston 101 is a piston that converts the explosive force of a fuel-air mixture into mechanical motion, and slides up and down within a cylinder 102. Cylinder 102 in turn is configured to slide up and down, co-axially with piston 101, within a cylinder housing 103. Piston 101 is illustrated in the top dead center (TDC) position.

A spark plug 104 is connected to a spark plug wire 105 to ignite a fuel-air mixture in cylinder 102. Spark plug 104 passes through cylinder housing 103 via a slot 106. It should be understood that FIG. 1 is a cross-sectional side view, and that piston 101 and cylinder 102 are predominantly figures of rotation that are circular when viewed downwardly, from the top of FIG. 1. Slot 106 is wide enough to enable spark plug 104 to pass through cylinder housing 103, which surrounds cylinder 102. Slot 106 is elongated in the direction in which piston 101 and cylinder are able to move, so that spark plug 104 can move along with cylinder 102, without striking cylinder housing 103.

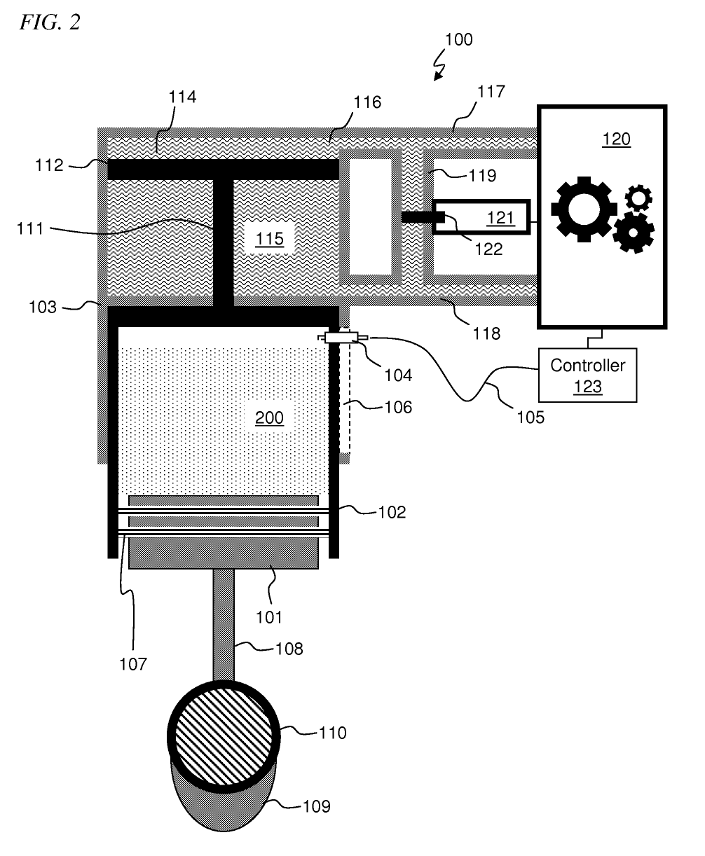

Piston 101 has a set of piston rings 107, which are labeled only in FIG. 2, for clarity. Returning to FIG. 1, a connecting rod 108 connects piston 101 to an offset lobe 109 of crankshaft 110. Piston 101, spark plug 104, spark plug wire 105, connecting rod 108, lobe 109, and crankshaft 110 may be largely similar to their prior art equivalents, except that connecting rod 108 may be somewhat elongated when compared with prior art engines.

A novel aspect of the invention is the ability of cylinder 102 to move up and down within cylinder housing 103 in a controlled manner, as piston 101 moves up and down within cylinder 102. This coordinated dual movement is what enables dynamically altering piston displacement.

Cylinder 102 is connected to a stem 111, which is then connected to a displacement piston 112. The assembly of cylinder 102, stem 111, and displacement piston 112 should be interpreted as a figure of rotation that is shaped similarly to an inverted wine glass. Displacement piston 112 performs a different role than power piston 101. Whereas power piston 101 converts the force of an explosion (on only one face) into mechanical movement, similar to a piston in a prior art engine, displacement piston 112 controls movement of stem 111, and thus anything connected to stem 111, based on the forces of hydraulic fluid on opposing faces. Displacement piston 112 operates somewhat similarly to a piston within a shock absorber, rather than a piston within an engine.

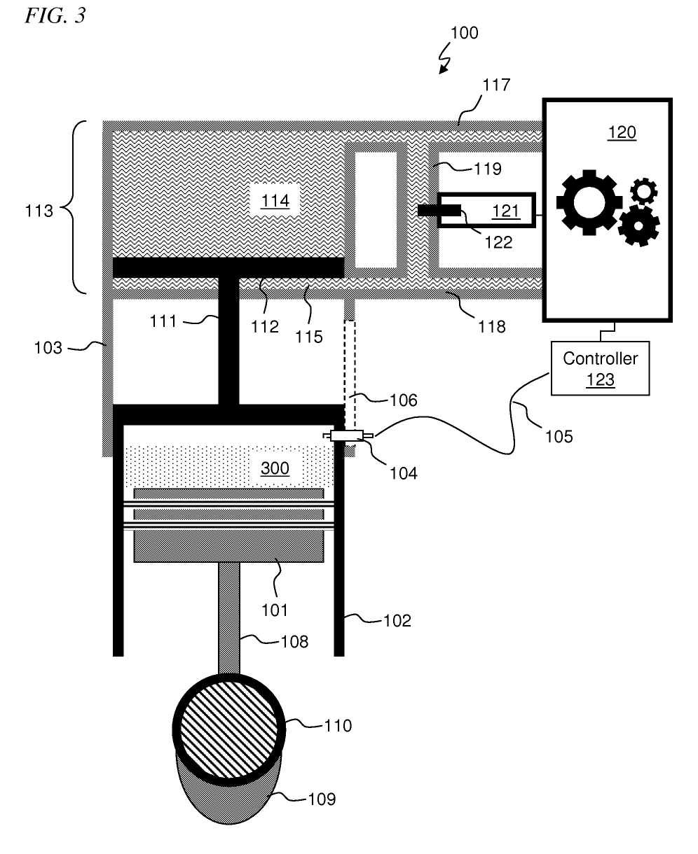

Displacement piston 112 moves within a hydraulic cylinder 113, which should be considered to be largely a figure of revolution, with the exception of fluid passage tubes 117 and 118, which will be described later. See FIG. 3 for another annotation of hydraulic cylinder 113. Returning to FIG. 1, hydraulic cylinder 113 has two portions: an upper chamber 114, which is above displacement piston 112, and a lower chamber 115, which is below displacement piston 112. Hydraulic cylinder 113 is filled with hydraulic fluid 116, which may require cooling, due to its proximity to a combustion heat source within cylinder 102. In FIG. 3, it can be seen that the relative sizes of upper chamber 114 and lower chamber 115 can vary, based on movement of displacement piston 112.

Fluid passage tubes 117 and 118 couple to upper chamber 114 and lower chamber 115, respectively, to enable introduction and evacuation of hydraulic fluid 116. If both fluid passage tubes 117 and 118 are blocked, in order to prevent movement of fluid, then because hydraulic fluid is essentially uncompressible, upper chamber 114 and lower chamber 115 cannot change sizes, and cylinder 102 will remain in place without significant movement. It should be understood that FIG. 1 illustrates a cross sectional cut of system 100 that includes fluid passage tubes 117 and 118, but that fluid passage tubes 117 and 118 are not part of the figure of rotation that includes the majority of hydraulic cylinder 113.

Fluid passage tubes 117 and 118 couple together via a gated fluid passage tube 119 and a reversible hydraulic pump 120. Pump 120 can be configured to block motion of fluid into or out from either of fluid passage tubes 117 and 118, as well as pump fluid under pressure into either of fluid passage tubes 117 and 118 or evacuate fluid from either of fluid passage tubes 117 and 118. Pump 120 may further comprise a hydraulic fluid reservoir, because stem 111 occupies volume within hydraulic cylinder 113, and as displacement piston 112 moves within hydraulic cylinder 113, the amount of hydraulic fluid 116 within hydraulic cylinder 113 will vary.

A solenoid 121 actuates a gate valve 122 to either open or block a gated fluid passage tube 119. Operating pump 120 to pressurize fluid passage tube 117 and simultaneously evacuate hydraulic fluid 116 from fluid passage tube 118 will expand the volume of upper chamber 114 and reduce the volume of lower chamber 115. This action will then force displacement piston 112, and thus cylinder 102, downward. The reverse operation, pressurizing fluid passage tube 118 and evacuating hydraulic fluid 116 from fluid passage tube 117 will expand the volume of lower chamber 115 and reduce the volume of upper chamber 114, drawing displacement piston 112 and cylinder 102 upward. Pump 120 and solenoid 121 are controlled by an engine management system controller 123, which may also manage other engine operations.

Additional forces could also potentially move cylinder 102. As power piston 101 moves through the 4-stage engine cycle of intake, compression, power, and exhaust, cylinder 102 may have either upward forces (compression, power, exhaust) or downward forces (vacuum during intake). Some of these forces may be coincident with a desired direction of movement for cylinder 102. To take advantage of these forces in moving cylinder 102, and thereby reduce the demand on pump 120, solenoid 121 may actuate gate valve 122 at selected times to allow hydraulic fluid 116 to pass through fluid passage tube 119. This then enables the volumes of upper chamber 114 and lower chamber 115 to change, by allowing hydraulic fluid to pass between fluid passage tubes 117 and 118.

Turning now to FIG. 2, piston 101 is illustrated at the bottom position, fully retracted, with lobe 109 opposite its earlier position when piston 101 was at TDC. The displaced volume 200 is illustrated as a dot-shaded region. It should be understood that displaced volume 200 is cylindrical, and is a figure of rotation. Its volume, V, is calculated by V=π×D×S, where D is the diameter of the piston 101, and S is the length of the piston stroke (the distance between the top and bottom piston positions).

By convention, since the early days of automotive history, engine sizes have been identified by calculating the volume displaced by a piston during one rotation of the crankshaft, and then multiplying by the number of cylinders in the engine. In prior art multi-displacement engines, the volume displaced by a piston during one rotation of the crankshaft does not change. That is, the piston displacement does not change in the prior art systems. The only thing that changes in the prior art systems is the number of pistons that are included as being part of the engine, which means changing only the number by which the piston displacement is multiplied.

For prior art multi-displacement engines, the engine size calculation is defined in a slightly different manner: instead of multiplying the piston displacement by the number of cylinders, the piston displacement is multiplied by the number of pistons that actively contribute to engine power. Thus, engine displacement can “change” merely by starving a cylinder of fuel, so that the fuel-starved cylinder does not contribute power to the engine. This convention applies to enable marketers to claim that an engine's displacement changes, even when every piston within the engine continues to displace the exact same volume as it did before the fuel-starving method took effect.

In the new system, however, the actual volume displaced by a piston during one rotation of the crankshaft does change. Thus, the new system alters physical piston displacement, rather than merely allegedly altering engine displacement by omitting cylinders from a calculation.

This displacement alteration can be seen by comparing FIG. 3 with FIG. 2. In FIG. 3, cylinder 102 has moved downward. Piston 101 is still illustrated as being in the bottom position, similar to FIG. 2, but the displaced volume 300 in FIG. 3 is noticeably smaller than displaced volume 200. This is because cylinder 102 has moved a portion of the distance that piston 101 has moved, in the same direction. As a result, the displaced volume (i.e., the piston displacement) has been altered between FIGS. 2 and 3. The calculation for the new displaced volume 300 is calculated by V=π×D×(S_{P}−S_{C}), where S_{P} is the length of the piston 101 stroke, and S_{C} is the length of the cylinder 102 stroke (motion along with piston 101).

The dynamic alteration, A, of piston displacement between FIGS. 2 and 3 is the difference between displaced volume 200 and displaced volume 300, which can be calculated as |A|=|π×D×S_{C}|. The calculation is done in absolute value. This dynamic alteration is not possible in prior art multi-displacement systems. In prior art engines, piston displacement can only be altered by disassembling the engine and either changing the crankshaft or else changing the internal diameter of a cylinder by either boring or use of a narrowing sleeve.

It should be noted that cylinder 102 will move downward during an intake stroke of piston 101, and should return to its upper position, illustrated in FIGS. 1 and 2, as piston 101 completes a compression stroke, in order to prevent piston 101 from striking spark plug 104. During the explosion (power stroke) and exhaust, cylinder 102 may not move. Thus, cylinder 102 may move only every other rotation of crankshaft 110. As mentioned earlier, during an intake stroke, the vacuum caused by the downward movement of piston 101 may pull cylinder 102 along, in addition to drawing in a fuel-air mixture. Also, during a compression stroke, the pressure caused by the upward movement of piston 101 may push cylinder 102 back toward the uppermost position, in addition to compressing the fuel-air mixture. Opening gate valve 122 may enable these forces to move cylinder 102, although such forces may not be sufficient and supplemental force may be required from pump 120.

One limitation on the performance of system 100 is that the inertia of hydraulic fluid 106, along with the response time of pump 120, and resistance to fluid movement within fluid passage tubes 117 and 118, will limit the speed of engine rotation. That is, system 100 may have an upper rev limit, measured in revolutions per minute (RPM) that is lower than an RPM limit for a comparably-sized prior art engine. This is a trade-off for achieving dynamically variable piston displacement.

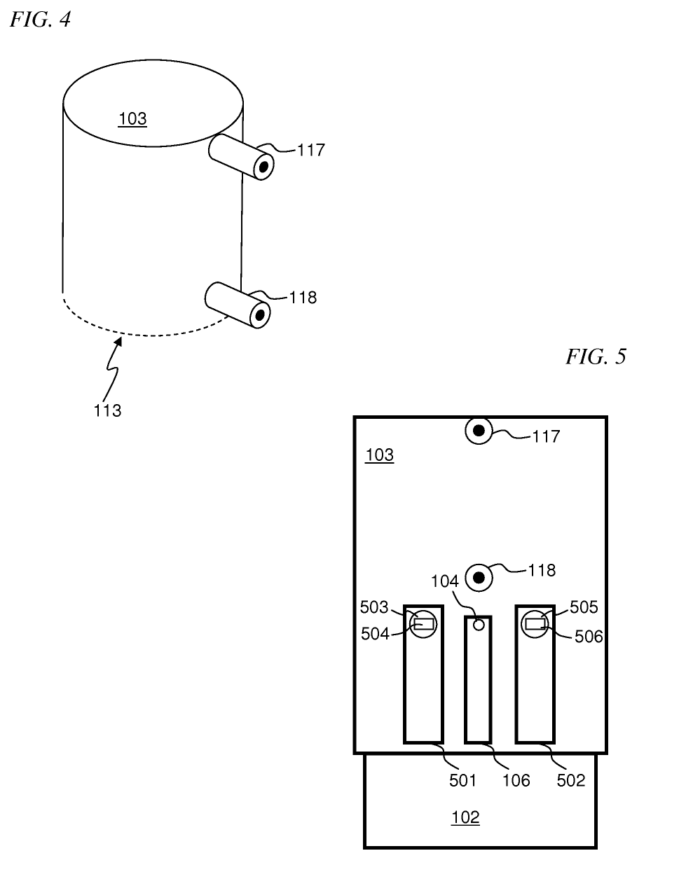

FIG. 4 provides a perspective view of the upper portion of cylinder housing 103. The bottom of the illustrated portion of cylinder housing 103 in FIG. 4 is dashed to indicate that an additional portion of cylinder housing 103 continues below the bottom of the figure.

FIG. 5 illustrates a portion of an embodiment of a valve assembly for system 100. Cylinder housing 103 is illustrated from a different viewing position than that of FIGS. 1 through 3. The view illustrated in FIG. 5 is from the right side of FIGS. 1 through 3, whereas the view illustrated in FIGS. 1 through 3 is from the left side of FIG. 5. In FIG. 5, for example, fluid passage tubes 117 and 118 are seen to have circular cross-sections, and slot 106 in cylinder housing 103 is illustrated to show an end view of spark plug 104, which is attached to cylinder 102. Two additional slots are illustrated, which are an intake valve slot 501 and an exhaust valve slot 502. Valve slots 501 and 502 will enable valve stems and springs, that are attached to a valves that move with cylinder 102, to move up and down without striking cylinder housing 103. Valve slots 501 and 502 provide the same function for the intake and exhaust valves as slot 106 provides for spark plug 104.

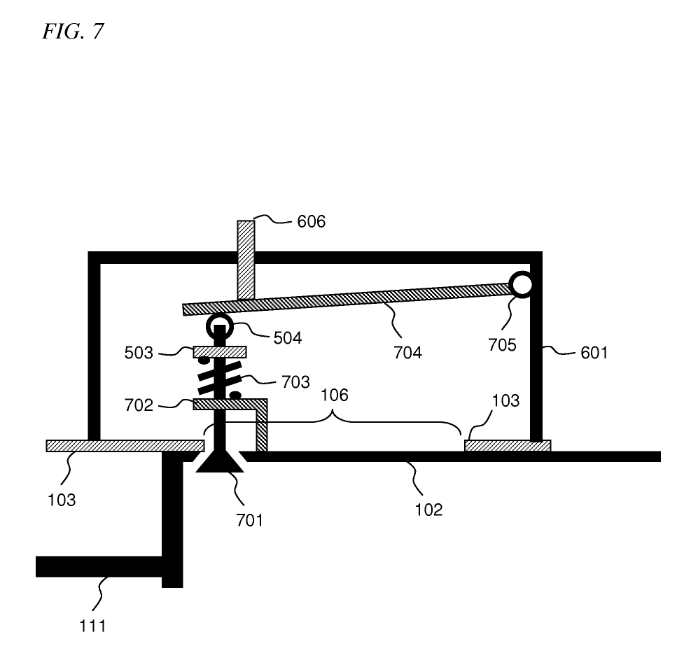

Two valves are indicated in the figure, although the illustration only shows an intake valve keeper disk 503 and an intake valve stem roller 504, which obscure an intake valve, and also an exhaust valve keeper disk 505 and an exhaust valve stem roller 506, which obscure an exhaust valve. A more detailed side view of a valve assembly will be provided in FIG. 7.

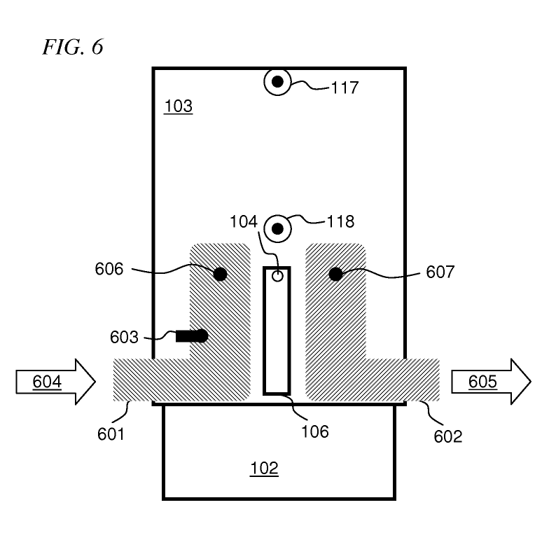

FIG. 6 illustrates cylinder housing 103 from the same viewing angle as FIG. 5, although with intake manifold runner 601 and exhaust manifold 602 in place, obscuring valve slots 501 and 502. Intake manifold runner 601 includes a fuel injector 603, for squirting fuel into the intake, nearby the intake valve. In operation, a stream of air 604 enters intake manifold runner 601, and mixes with fuel from fuel injector 603, and then passes through an intake valve into cylinder 102. Because intake manifold runner 601 seals against the outside of cylinder housing 103 and is sufficiently elongated to cover the entire extent of intake valve slot 501, stream of air 604 can enter cylinder 102 at whatever position the intake valve may be located within intake valve slot 501. Exhaust manifold 602 is similarly configured, with respect to covering exhaust valve slot 502 and sealing against cylinder housing 103, although exhaust manifold 602 lacks a fuel injector. Other sensors, such as those commonly used in prior art engine management systems, may be coupled to exhaust manifold 602.

Exhaust gasses 605 pass out of cylinder 102, in whatever position the exhaust valve may be located within exhaust valve slot 502, and through exhaust manifold 602, to be silenced, measured, and processed according to any required muffler and pollution control systems attached to system 100. To prevent undesired leakage of stream of air 604 and exhaust gasses 605, the exterior of cylinder 102 should seal fairly tightly against the interior of cylinder housing 103. An intake valve lifter rod 606 and an exhaust valve lifter rod 607 are illustrated, end-on, passing through intake manifold runner 601 and exhaust manifold 602, respectively. Valve lifter rods 606 and 607 may be operated by a camshaft, lifter, and rocker arms (not pictured), as is well-know in the art.

FIG. 7 illustrates an embodiment of a valve assembly. It should be understood that, although the figure is explained as an intake valve assembly, an exhaust valve assembly may be similarly configured. Thus, merely by changing the designations and taking into account other annotations that follow, FIG. 7 effectively also illustrates an exhaust valve assembly.

An intake valve 701 passes through cylinder 102 and a spring platform 702, which is affixed to the exterior of cylinder 102, and travels with cylinder 103, as cylinder 103 moves within cylinder housing 103. The right side of spring platform 702 may be vented or partially open on the right side vertical portion, to enable air to pass through in the way to the interior of cylinder 102. This prevents the air from having to travel around to the left side of spring platform 702, in order to enter cylinder 102. A valve spring 703 rests against the exterior top of spring platform 702 and is compressed against the underside of valve keeper disk 503. Valve spring 703 is operable to keep intake valve 701 in a closed position, unless an opening force is provided to open valve 701 against the pressure of valve spring 703. This operation is similar to prior art valve spring operation. Valve keeper disk 505 may be held in place against intake valve 701 using a slot in the stem of valve 701, as is well-known in the art. Valve 701 is illustrated as partially open, so valve spring 703 is partially compressed.

Intake valve 701 terminates at the end opposite cylinder 102 with intake valve stem roller 504, which rolls against a valve lifter plate 704, as cylinder 102 (and thus valve 701) move relative to cylinder housing 103 (and thus valve lifter plate 704). Valve lifter plate 704 is affixed to intake manifold runner 601 by a lifter plate hinge 705, which enables valve lifter plate 704 to pivot under the force of valve lifter rod 606.

In operation, as a camshaft rotates so that a camshaft lobe presses against a lifter and then transfers force through a lifter and possibly a rocker arm, valve lifter rod 606 presses against one side of valve lifter plate 704, moving it. The opposite side of valve lifter plate 704 then presses against intake valve stem roller 504, moving it to open valve 701 against the force of intake valve spring 703. Intake valve spring 703 is then compressed between valve keeper disk 505 and spring platform 702. As the engine camshaft rotates further, and the camshaft lobe enables valve lifter rod 606 to begin retracting, valve spring 703 pushes upward (as in the illustrated orientation) against valve keeper disk 505, using spring platform 702 as a base, to close intake valve 701.

Cylinder 102 is able to move, even with intake valve 701 actuated into an open position, because intake valve stem roller 504 rolls, rather than drags, along valve lifter plate 704. It can be noted that valve lifter plate 704 is angled, due to the pivot point residing at the position of lifter plate hinge 705 on intake manifold runner 601. Thus, as cylinder 102 moves rightward (as in the illustrated orientation, which is downward in the orientation of FIGS. 1 through 5), valve lifter plate 704 provides less opening distance for intake valve 701. The more cylinder 102 moves, the more pronounced the difference in the opening distance of intake valve 701. This may be desirable, because the more cylinder 102 moves, the less the piston displacement, which means less air is drawn into cylinder 102. It is well-known in the art that engines with less displacement require less capacity of gas volume passing through the valves. That is, a smaller engine does not need as large diameter valves as a larger engine, or if the valves are the same diameter as in the larger engine, the valves do not need to be opened as much. Therefore, the reduction in the airflow capacity past valve 701, as cylinder 102 moves by large amounts, may be preferable over attempting to preserve the same airflow capacity as if cylinder 102 were not moving and had the maximum opening distance for intake valve 701. For the exhaust stroke though, cylinder 102 might not move, and this phenomenon, of the valve beginning to close merely due to the movement of cylinder 102, is not observed.

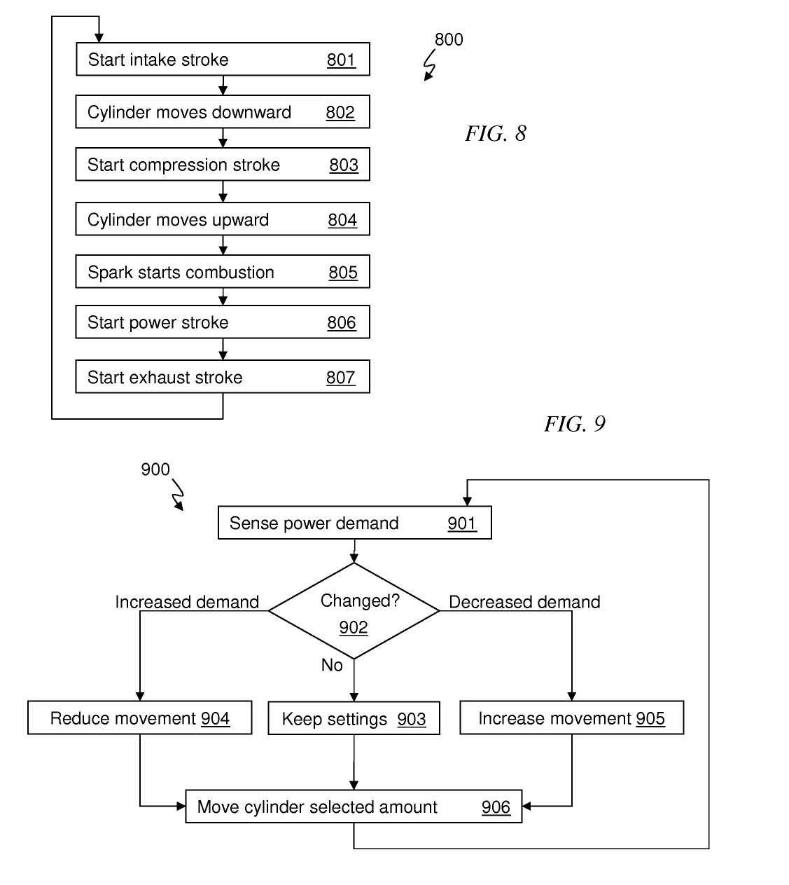

FIG. 8 illustrates a flowchart of a method 800 for dynamically altering piston displacement. The embodiment illustrated in FIG. 1 will be used for an example. In box 801, the intake stroke starts, and cylinder 102 moves downward (although by a lesser distance), along with piston 101, in box 802. Piston 101 moves by an amount S_{P}, whereas cylinder 102 moves by an amount S_{C}. As indicated earlier, S_{P}>S_{C}. The value of S_{C} is selected by controller 123, in an attempt to meet power demands on the engine, while minimizing piston displacement to maximize fuel economy. Selection of the specific S_{C} value is in accordance with a method 900, which is described next.

In box 803, the compression stroke starts, so in box 804, cylinder 102 moves upward to prevent piston 101 from striking spark plug 104. A spark from spark plug 104 starts combustion of the fuel-air mixture in box 805, which starts the power stroke in box 806. Cylinder 102 does not move downward with piston 101 during the power stroke, because this would be against the pressure of the combustion expansion. In box 807, piston 101 moves upward again for the exhaust stroke. Method 800 then returns to box 801.

FIG. 9 illustrates a flowchart of method 900 for dynamically altering piston displacement. Specifically, method 900 enables selection of the S_{C} value that balances engine power with fuel economy. In box 901, system 100 is operating with some S_{C} value, which may be zero at engine start-up or some other value after operation has been ongoing for some time. Controller 123 senses the power demand on the engine. Such power demand sensing is well-known in the art, and is commonly used in computer-controlled automatic transmissions, as well as prior art multi-displacement systems. Engine intake vacuum, accelerator pedal position, and RPM are often used as inputs to logic systems that estimate engine power demand.

In decision box 902, controller 123 identifies one of three possibilities: no change sensed, a power increase is needed, and a power decrease is tolerable. If no change is sensed, then controller 123 retains the prior S_{C} value in box 903. If however, there is an increased demand for engine power, then the engine should operate at a greater displacement—that is, if it is not already operating at maximum displacement. So, in box 904, controller 123 reduces S_{C}. The relationship between engine displacement (presumably power, too) and cylinder movement is inverse. The greater the movement of cylinder 102 (the greater the value of S_{C}), the lower the engine displacement. The less the movement (the less the value of S_{C}), the greater the engine displacement. Thus, if controller 123 senses that engine power may be reduced, controller 123 will increase S_{C} up to its maximum permitted amount. Hopefully, this will save fuel, because there is less displacement of piston 101 to pull a fuel-air mixture during the intake stroke.

Whichever selection controller 123 made, whether box 903, 904 or 905, the new value of S_{C} has now been set, and is used in box 906. Box 906 of method 900 intersects with box 802 of method 800, because it is the value of S_{C} selected by method 900 that is used in method 800. After the current engine cycle is complete, method 900 returns to box 901.

Although the invention and its advantages have been described herein, it should be understood that various changes, substitutions and alterations can be made without departing from the spirit and scope of the claim. Moreover, the scope of the application is not intended to be limited to the particular embodiments described in the specification. As one of ordinary skill in the art will readily appreciate from the disclosure, alternatives presently existing or developed later, which perform substantially the same function or achieve substantially the same result as the corresponding embodiments described herein, may be utilized. Accordingly, the appended claim is intended to include within its scope such alternatives and equivalents.

1. Dynamically altering combustion piston displacement.
